(19) United States
(12) Patent Application Publication
(10) Pub. No.: US 2012/0056414 A1
(43) Pub. Date: Mar. 8, 2012

(54) EXHAUST SYSTEM CONDUIT WITH THERMAL/NOISE INSULATION

(76) Inventors: R. Winfield THOMAS, West Lebanon, IN (US); Robert F. STALCUP, II, Covington, IN (US); Scott R. SWANK, Williamsport, IN (US)

(21) Appl. No.: 13/297,680

(22) Filed: Nov. 16, 2011

Related U.S. Application Data
(63) Continuation-in-part of application No. 12/569,630, filed on Sep. 29, 2009.
(60) Provisional application No. 61/507,508, filed on Jul. 13, 2011.

(51) Int. Cl. F16L 59/153; F16L 59/16; F16L 11/15; F16L 59/147; F16L 11/16

(52) U.S. Cl. 285/49

(57) ABSTRACT

A flexible conduit for use in a pipe system such as a vehicular exhaust system to provide a torsional or non-torsional joint between two pipes. The conduit has an outer bellows, an inner liner and at least one layer of noise/thermal insulation to attenuate noise, resist thermal transmission and dampen vibration.

### CROSS-REFERENCE TO RELATED APPLICATIONS

This Application is a Continuation-in-Part of and claims priority to U.S. patent application Ser. No. 12/569,630 filed Sep. 29, 2009 to R. Winfield Thomas, Robert F. Stalcup II and Scott R. Swank entitled “Exhaust System Conduit with Thermal/Noise Insulation,” currently pending, the entire disclosure of which is incorporated herein by reference. This Application also claims priority to U.S. Provisional Application Ser. No. 61/507,508, filed on Jul. 13, 2011 to Clark Thomas and Scott R. Swank entitled “Frequency-Controlled Exhaust Bellows Assembly,” the entire disclosure of which also is incorporated herein by reference. This Application further claims priority to U.S. patent application Ser. No. 12/942,684, filed on Nov. 9, 2010 to Robert F. Stalcup II and Scott R. Swank entitled “Exhaust Connection Member with Preformed Braided Cover,” the entire disclosure of which also is incorporated herein by reference.

### FIELD OF THE INVENTION

This invention relates generally to the field of pipe systems and more particularly to a flexible pipe system such as the type commonly used in vehicular exhaust systems or farm equipment, construction equipment, or other equipment.

### BACKGROUND OF THE INVENTION

Flexible pipe and conduit structures are used in a variety of applications. For example, vehicular exhaust systems make use of flexible conduits in order to accommodate the jarring, vibration and thermal stresses to which the exhaust system is subjected when the vehicle is in use. Examples of spiral wound flexible pipes suitable for use in vehicular exhaust systems are disclosed in U.S. Pat. No. 6,497,254 to Thomas et al. Bellows type systems which provide flexibility by using corrugated conduits are exemplified by U.S. Pat. No. 7,066,495 to Thomas et al. The latter patent also discloses an arrangement for interfitting the corrugations on the pipes in a manner to allow relative rotation at the pipe joints.

These prior art exhaust systems function in a generally satisfactory manner for the most part. The flexibility of the pipes allows them to withstand the forces that are applied due to jolts, vibrations and thermal stresses. The rotary or torsional joint is especially beneficial in many applications because it is able to accommodate torsional loading without unduly stressing the pipes. Even so, the prior art exhaust systems of this type have not been completely free of problems.

In particular, the vibration and other movement creates substantial noise which can be aggravated by the hot exhaust gases going through the pipes. Additionally, the heat from the exhaust gases causes the outside surfaces of the pipes to reach temperatures that can be high enough to create undue heat stress on the piping and safety hazards if contacted by persons. These noise and heat problems have not been successfully addressed and have been increasing causes for concern due to the increasing emphasis that has been placed on controlling noise pollution and increasing concern with safety considerations.

### SUMMARY OF THE INVENTION

The present invention is directed to a flexible conduit system which may be used in a variety of applications, including in an exhaust system for an engine used on vehicles, farm equipment, construction equipment or other equipment. In accordance with one embodiment of the invention, a conduit which is used to couple together a pair of pipes is constructed with a corrugated outer portion, an inside portion which may be a spirally wound strip with interlocked edges, and a layer of insulation sandwiched between the inside and outside portions. In another embodiment, the conduit includes a cover surrounding the outer portion and the insulation layer is located between the outer portion and the cover. In yet another embodiment, a first insulation layer is sandwiched between the inside and outside portions and a second insulation layer is located between the outer portion and the cover.

The insulation layer may be constructed of any suitable material that is effective to suppress noise transmission within the conduit and to resist heat transmission. Additionally, the insulation provides a barrier that dampens vibration and prevents the inside and outside portions, and optionally the outer portion and the cover, of the conduit from physically contacting each other. As a consequence, the conduit exhibits improved noise control, reduced heat transmission, diminished vibration, and enhanced structural capabilities. The conduit provides particular utility as a joint between two pipes, and the conduit may be constructed to include either a torsional joint(s) or a non-torsional joint(s) depending upon the application.

Other and further objects of the invention, together with the features of novelty appurtenant thereto, will appear in the course of the following description.

### BRIEF DESCRIPTION OF THE SEVERAL VIEWS OF THE DRAWING

In the accompanying drawings, which form a part of the specification and are to be read in conjunction therewith in which like reference numerals are used to indicate like or similar parts in the various views:

FIG. 1 is a sectional view showing a conduit constructed according to one embodiment of the present invention, with the conduit having a configuration to provide a torsional joint between a pair of pipes;

FIG. 2 is a fragmentary sectional view on an enlarged scale of the detail identified at 2-2 in FIG. 1;

FIG. 3 is a sectional view of a conduit constructed according to another embodiment of the present invention, with the conduit arranged to provide a non-torsional joint;

FIG. 4 is a fragmentary sectional view on an enlarged scale of the detail identified at 4-4 in FIG. 3;

FIG. 5. is a sectional view of a conduit constructed according to another embodiment of the present invention, with the conduit arranged to provide a non-torsional joint and having insulation material between the bellows and cover;

FIG. 6 is a fragmentary sectional view on an enlarged scale of the detail identified at 6-6 in FIG. 5;

FIG. 7 is a sectional view of a conduit constructed according to another embodiment of the present invention, with the conduit arranged to provide a non-torsional joint and having insulation material between the inside liner and bellows and between the bellows and cover;

FIG. 8 is a fragmentary sectional view on an enlarged scale of the detail identified at 8-8 in FIG. 7;

FIG. 9 is a sectional view of a conduit constructed according to another embodiment of the present invention, with the cover positioned at a predetermined space from the bellows and having insulation material between the bellows and cover; and

FIG. 10 is a sectional view of a conduit constructed according to another embodiment of the present invention, with the cover positioned at a predetermined space from the bellows and having insulation material between the inside liner and bellows and between the bellows and cover.

### DETAILED DESCRIPTION OF THE PREFERRED EMBODIMENTS

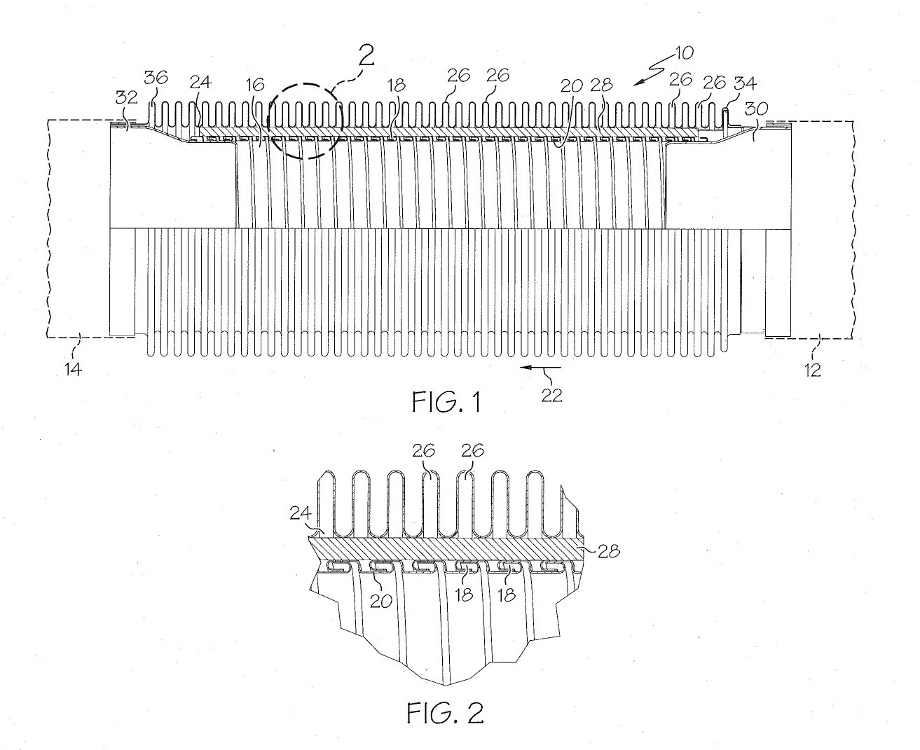

Referring now to the drawings in more detail and initially to FIG. 1, numeral 10 generally designates a conduit which is constructed according to one embodiment of the present invention. The conduit 10 may couple together a pair of pipes 12 and 14. By way of example, the conduit 10 and the pipes 12 and 14 may be parts of a vehicular exhaust system through which exhaust gases flow.

The conduit 10 has an inner cylindrical liner portion 16 which may be constructed as a flexible conduit formed by a spirally wound strip 18 having edges of adjacent windings interlocked in the manner described in U.S. Pat. No. 6,427,727 to Thomas which is incorporated herein by reference. The liner portion 16 has a flexible construction which allows it to flex in a manner to withstand the forces that are applied to it in service. The liner portion 16 provides a cylindrical bore 20 through which the hot vehicular exhaust gases pass from pipe 12 to pipe 14, as shown by the directional arrow 22 in FIG. 1.

An outer portion of the conduit 10 is formed by a bellows 24 which extends around the liner 16 and has a plurality of corrugations 26 on its outer surface. The bellows 24 may be constructed in the manner disclosed in U.S. Pat. No. 7,066,495 to Thomas et al. which is incorporated herein by reference. Alternatively, the outer portion of conduit 10 may be constructed as a braided structure, an interlock flexible hose or in another manner providing flexibility to the conduit.

A cylindrical insulation blanket 28 is sandwiched between the inside conduit 16 and the bellows 24. The layer or blanket 28 may be constructed of any material that is effective to attenuate noise, resist heat transmission, and/or dampen vibration. One material that is satisfactory for the blanket 28 is commercially available silica or silicone fiber insulation. However, other materials having the necessary characteristics can also be used. The blanket 28 can have two components: (1) a woven fiber layer and (2) a fibrous material layer. The woven fiber layer serves to protect the liner 16 against wear and serves to prevent the infiltration of the fibers from the insulation through the liner 16 and into the exhaust stream. The insulation material that forms the blanket 28 may be comprised of any suitable configuration, including but not limited to (1) only a fibrous material, (2) only a woven material, (3) a fibrous material with a woven material on one side or the other or (4) a fibrous material sandwiched between and having woven materials on both sides. The blanket 28 is enclosed within the conduit structure provided by the bellows 24 on the outside and the inside liner 16 on the inside.

The conduit 10 may be equipped with a pair of end fittings 30 and 32 which are located on the opposite ends of the conduit 10. Fitting 30 has at least one exterior corrugation 34 that interfits with a mating corrugation 26 on or near the end of the bellows 24. The fit between these corrugations allow the fitting 30 to rotate relative to the bellows 24 with the corrugations continuing to mate during such rotation in order to maintain the integrity of the rotary or torsional joint. Similarly, fitting 32 has at least one corrugation 36 that interfits with a mating corrugation 26 on or near the opposite end of the bellows 24. This allows fitting 32 to rotate relative to bellows 24 similarly to fitting 30. Pipes 12 and 14 may be connected to the respective fittings 30 and 32 by welding or in any other suitable matter. In this way, the pipes 12 and 14 are allowed to rotate relative to the conduit 10 to relieve torsional stresses that may be applied to the pipe structure during use. The fittings 30 and 32 and torsional joints may be constructed in the manner described in U.S. Pat. No. 7,066,495 to Thomas et al.

When the conduit 10 is used in a vehicular exhaust system, the flexibility provided by the strip wound inside liner portion 16 and the outer bellows 24 accommodates jolting, vibration and thermal stresses to which the exhaust system is subjected. The torsional joint provided by the rotary connections of the fittings 30 and 32 enables the pipe system to withstand rotary or torsional loads without undue stress.

The insulation blanket 28 is of particular importance because it reduces the noise that is generated within the piping system as the vehicle operates and hot exhaust gases flow through the pipes 12 and 14 and the conduit 10. At the same time, the thermal insulation provided by the blanket 28 reduces the heat transmission from the inside to the outside of the conduit 10, and the corrugations 26 act as cooling fins to dissipate the heat from the bellows 24. The insulation 28 also serves to dampen vibration of the pipe system and thus reduces the fatigue forces that can weaken pipe systems of this type over prolong periods of operation.

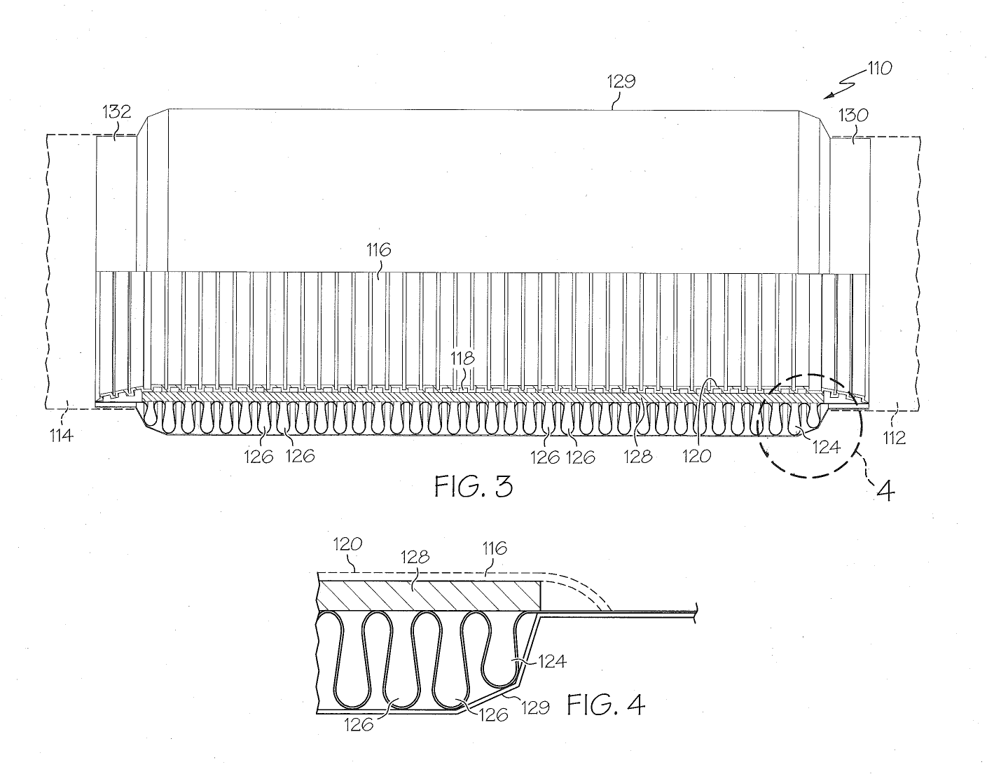

Referring now to FIG. 3, numeral 110 generally identifies a conduit constructed according to a second embodiment of the invention. The conduit 110 is used to connect a pair of pipes 112 and 114 which may be part of a vehicular exhaust system or another type of pipe system.

The conduit 110 has an inside liner 116 which may be a spirally wound strip 118 interconnected at its edges in the manner described previously for conduit 16. The liner 116 provides a cylindrical bore 120 aligned with the bores of pipes 112 and 114 to accommodate the flow of materials such as hot exhaust gases from pipe 112 to pipe 114.

An outer portion of the conduit 110 is provided by a bellows 124 having a plurality of corrugations 126 on its outside surface. The bellows 124 may be constructed generally in the same manner as bellows 24.

An insulation blanket 128 is enclosed within conduit 110 between the inside liner 116 and bellows 124. The blanket 128 serves the same function as blanket 28 and may be constructed of the same materials and in a similar cylindrical configuration.

As best shown in FIG. 4, a flexible cover 129 may be used to closely cover the entirety of the conduit 110. The cover 129 may be secured in place by any suitable means and may be constructed of any suitable material, preferably wire braid.

The conduit 110 is provided with end flanges 130 and 132 which may be integral with the inside tube 116 and/or the bellows 124. The end fittings 130 and 132 are cylindrical and provide a convenient means for attaching conduit 110 to the pipes 112 and 114, as by welding the pipes to the end fittings.

In the embodiment of FIGS. 3 and 4, the conduit 110 provides a non-torsional joint between the pipes 112 and 114. The insulation blanket 128 provides the same noise attenuation, heat resistance and vibration dampening as blanket 28 when the pipe system is in service as a vehicular exhaust system or otherwise.

As illustrated in FIGS. 3 and 4, the insulation blanket 128 extends substantially continuously along a length defined by the plurality of corrugations 126. However, in a variation of the embodiment illustrated in FIGS. 3 and 4, the insulation blanket 128, like the insulation blanket 28 in conduit 10, does not extend to the outermost corrugations 126 of the bellows 124. Rather, the insulation blanket 128 may terminate just short thereof such that a rotary or torsional joint may be implemented on one of both ends of the conduit 110 in the manner described previously for conduit 10. Like with conduit 10, the torsional joint may be achieved by providing one or both of the end flanges 103 or 132 with at least one exterior protruding corrugation that interfits with a mating corrugation 126 formed at or near the end of the bellows 124. The fit between these corrugations allows the end flanges 130 and 132 to rotate relative to the bellows 124 with the corrugations continuing to mate during such rotation in order to maintain the integrity of the rotary or torsional joint. As such, one or both of the non-torsional joints of the embodiment illustrated in FIG. 3 may be replaced with a torsional joint.

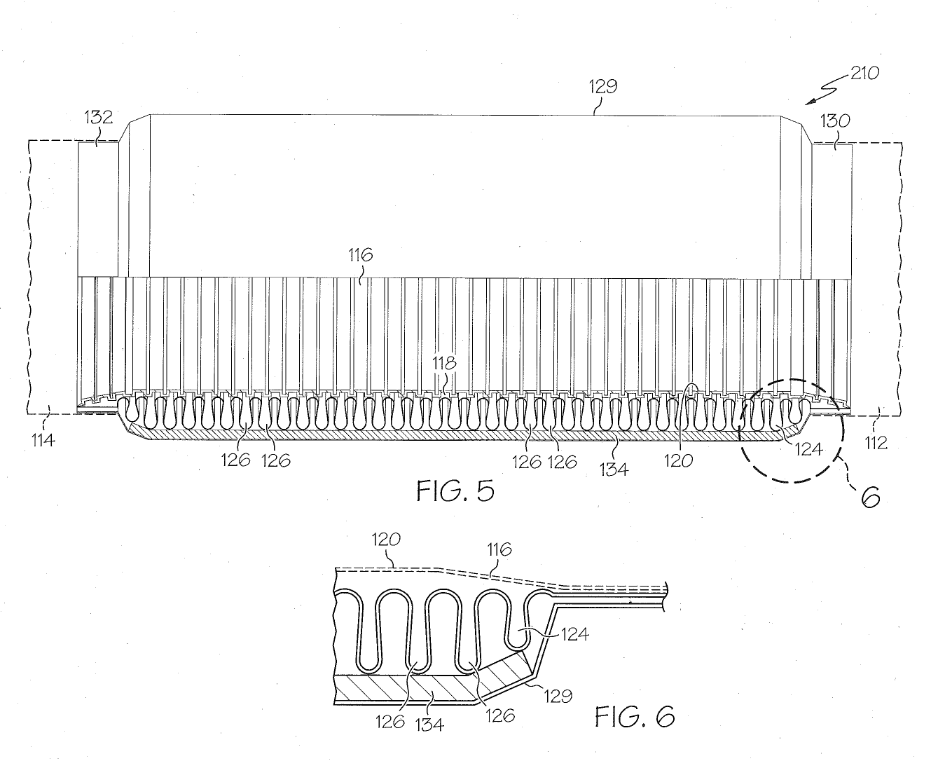

Referring now to FIG. 5, numeral 210 generally identifies a conduit constructed according to a third embodiment of the invention. The conduit 210 may be constructed in the manner described previously for conduit 110. However, as illustrated in FIGS. 5 and 6, an insulation blanket 134 is located between the bellows 124 and the cover 129, rather than between the inside liner 116 and bellows 124. The blanket 134 generally serves the same function as blankets 28 and 128 and may be constructed of the same materials and in a similar configuration. Like conduit 110, one or both of the ends 130 and 132 of conduit 210 may be constructed to form a torsional or non-torsional joint.

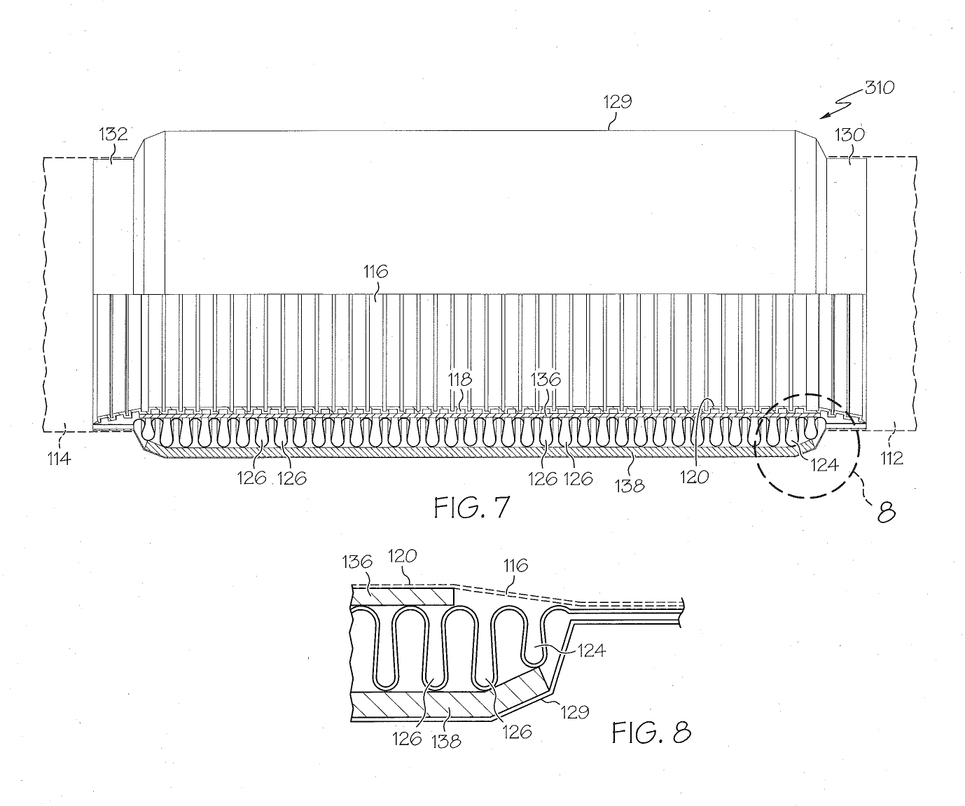

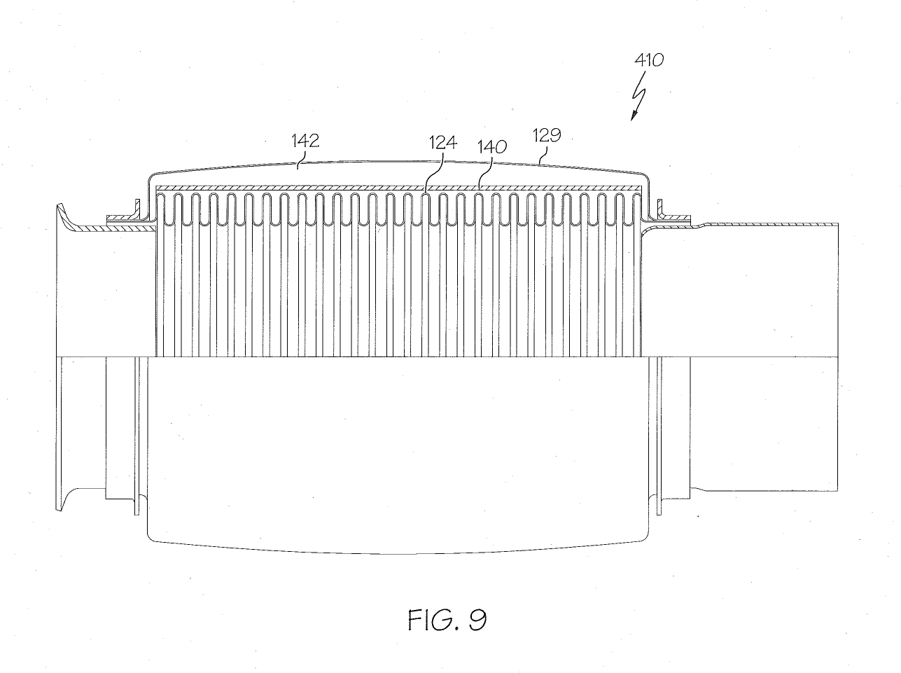

Referring now to FIG. 7, numeral 310 generally identifies a conduit constructed according to a fourth embodiment of the invention. The conduit 310 may be constructed in the manner described previously for conduits 110 and 210. However, as illustrated in FIGS. 7 and 8, the conduit may include two separate insulation blankets 136 and 138. As shown, blanket 136 is sandwiched between the inside liner 116 and the bellows 124, much like blankets 28 and 128 in conduits 10 and 110, respectively. Blanket 138 is located between the bellows 124 and the cover 129, much like blanket 134 in conduit 210. Blankets 136 and 138 generally serve the same functions as blankets 128 and 134, respectively, and may be constructed of the same materials and in similar configurations. Like conduit 110, one or both of the ends 130 and 132 of conduit 310 may be constructed to form a torsional or non-torsional joint.

FIG. 9 shows a fifth embodiment of the present invention wherein numeral 410 generally identifies a conduit having a cover 129 that is positioned at a predetermined space from the insulation blanket 140 surrounding the bellows 124. The cover 129 may act as a thermally insulating layer. The cover 129 may be formed into a predetermined shape prior to assembly with the remainder of the conduit 410. The cover 129 can include a generally cylindrical body section and two end sections each forming necks having diameters that are smaller than the diameter of the body section. The unique design of the cover 129 is such that the body section is self-supporting and does not require any additional support means for maintaining its space from the bellows 124 or surrounding insulation blanket 140. A thermally insulating air gap 142 is defined between the cover 129 and the bellows 124 in order to further increase the amount of heat maintained within exhaust gas flowing through the conduit 410.

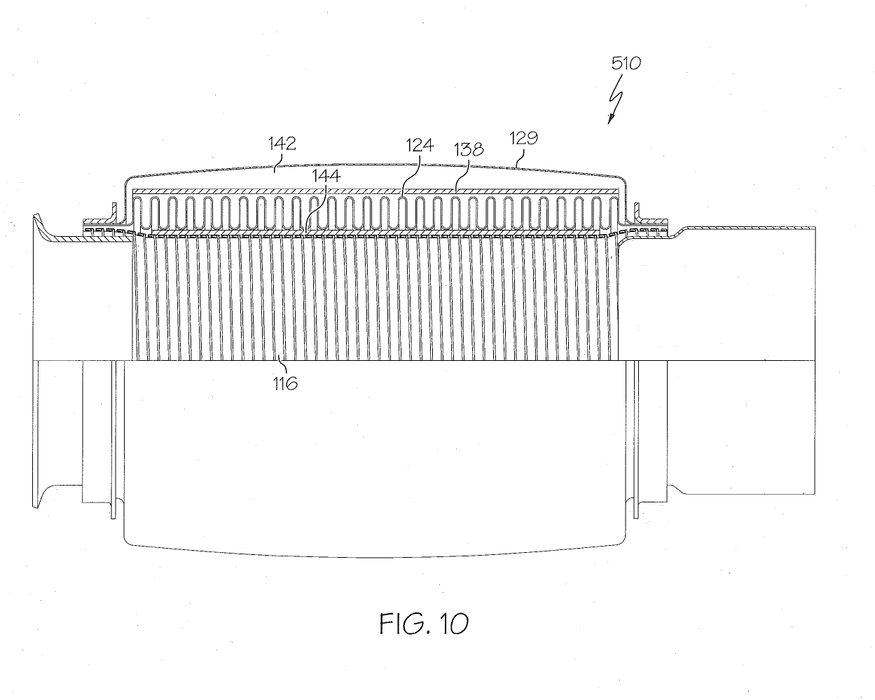

FIG. 10 illustrates a sixth embodiment of the present invention wherein numeral 510 generally identifies a conduit that is similar to conduit 410. However, as shown, conduit 510 includes an inside liner 116 and an insulation blanket 144 sandwiched between the inside liner 116 and the bellows 124. The conduit 510 may optionally include an insulation blanket 138 surrounding the bellows 124.

In yet another embodiment, the conduit of the present invention may comprise a liner, a cover and an insulation material located between the liner and cover.

From the foregoing it will be seen that this invention is one well adapted to attain all ends and objects hereinabove set forth together with the other advantages which are obvious and which are inherent to the structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative, and not in a limiting sense.

What is claimed is:

1. A flexible conduit structure for coupling first and second pipes, comprising:
a conduit having first and second ends for connection with said first and second pipes, respectively;
an outside portion of said conduit constructed in a manner to provide flexibility to said conduit;
an inside portion of said conduit connected to said outside portion and arranged to provide a bore through said conduit for the passage of fluid therethrough, said inside portion comprising a helically wound metal strip; and
a first insulation blanket sandwiched between said outside and inside portions, said first insulation blanket being constructed to suppress noise and heat transmission from within said conduit.

2. A conduit structure as set forth in claim 1, including a covering substantially surrounding said outside portion of said conduit.

3. A conduit structure as set forth in claim 2, wherein a portion of said covering is maintained at a predetermined space from said outside portion.

4. A conduit structure as set forth in claim 3, wherein said covering acts as a thermally insulating layer and a thermally insulating air gap is defined between said covering and said bellows in order to maintain heat within exhaust gas flowing through said conduit structure.

5. A conduit structure as set forth in claim 2, including a second insulation blanket located between said outside portion and said covering.

6. A conduit structure as set forth in claim 1, wherein said first insulation blanket comprises a woven fiber layer and a fibrous material layer.

7. A conduit structure as set forth in claim 1, wherein said first insulation blanket extends substantially continuously along a length defined by said plurality of corrugations.

8. A conduit structure as set forth in claim 1, wherein:
said conduit has a body portion between said first and second ends thereof; and
said body portion is connected with said first and second ends in a manner to allow rotation of said body portion relative to said first and second ends.

9. A conduit structure as set forth in claim 8, wherein:
said corrugations are formed on said body portion of said conduit; and
each of said first and second ends of said conduit has a corrugation that fits in a corrugation on said body portion in a manner to accommodate rotation of said body portion relative to said first and second ends.

10. A flexible conduit structure for a vehicle exhaust system, comprising:
a conduit having a liner forming a flow passage for flow of vehicle exhaust gases therethrough and an outer corrugation body having a plurality of corrugations to provide flexibility of said conduit;
a pair of end fittings on opposite ends of said conduit for connection to respective pipes between which said flow passage directs vehicle exhaust gases; and
a layer of insulation between said liner and said corrugated body constructed and arranged to suppress noise and heat transmission from within said conduit.

11. A conduit structure as set forth in claim 10, wherein said liner comprises a helically wound metal strip.

12. A conduit structure as set forth in claim 10, including a covering substantially enclosing said conduit.

13. A conduit structure as set forth in claim 12, wherein a portion of said covering is maintained at a predetermined space from said corrugated body.

14. A conduit structure as set forth in claim 13, wherein said covering acts as a thermally insulating layer and a thermally insulating air gap is defined between said covering and said corrugated body in order to maintain heat within exhaust gas flowing through said conduit structure.

15. A conduit structure as set forth in claim 10, including corrugations on said end fittings arranged to interfit with selected corrugations on said corrugated body in a manner to accommodate rotation of said conduit relative to said end fittings.

16. A flexible conduit structure for coupling first and second pipes, comprising:
first and second ends for connection with said first and second pipes, respectively;
a liner providing a flow channel through which vehicle exhaust gases can flow, said liner comprising a metal strip arranged in a helical winding;
an outside portion having a plurality of corrugations to accommodate flexing of said conduit, said outside portion being connected with said liner;
a covering substantially surrounding said outside portion, said covering comprising a wire braid; and
a first insulation layer.

17. A conduit structure as set forth in claim 16, wherein said first insulation layer is located either between said liner and said outside portion or between said outside portion and said covering.

18. A conduit structure as set forth in claim 16, including a second insulation layer, wherein said first insulation layer is located between said liner and said outside portion and said second insulation layer is located between said outside portion and said covering.

19. A conduit structure as set forth in claim 16, wherein said first insulation layer is constructed of a material effective to suppress noise and heat transmission from within said conduit structure.
